(19) United States
(12) Patent Application Publication
(10) Pub. No.: US 2005/0200124 A1
(43) Pub. Date: Sep. 15, 2005

(54) High temperature joints for dissimilar materials

(76) Inventors: Mark S. Kleefisch, Plainfield, IL (US); Joseph G. Masin, St. Charles, IL (US); John P. Collins, Kenai, AK (US); Sherman Xu, Katy, TX (US); Carl A. Udovich, Joliet, IL (US)

Correspondence Address: BP America Inc.;Docket Clerk, BP Legal, M.C. 5East, 4101 Winfield Road, Warrenville, IL, 60555, US

(21) Appl. No.: 10/800,227

(22) Filed: Mar. 12, 2004

(51) Int. Cl. F16L 47/00

(52) U.S. Cl. 285/290.1

(57) ABSTRACT

Composite joints for gas-tight members that exhibit different coefficients of thermal expansion are disclosed. Broadly, apparatus of the invention provides composite joints which include a girdle of a resilient material disposed between mating surfaces of a high strength metallic member and a nonmetallic member in an arrangement wherein a difference in fluid pressures across the joint provides compressive force upon the girdle through tapered mating surfaces thereby improving resistance to fluid leakage. Composite joints of the invention are particularly useful for joining a high strength weldable metallic conduit and a gas-tight ceramic member having a tubular structure, closed at one end, with a tapered mating surface at a distal end thereof contiguous with a portion of the girdle. Processes beneficially using joints in accordance with the invention include converting methane gas into value-added-products, for example, production of synthesis gas comprising carbon monoxide and molecular hydrogen. Advantageously, the synthesis gas is free of deleterious and/or inert gaseous diluents such as nitrogen.

### FIELD OF THE INVENTION

The present invention relates to composite joints for gas-tight members that exhibit different coefficients of thermal expansion. More particularly, this invention relates to composite joints resistant to fluid leakage which include a girdle of a resilient material disposed between mating surfaces of a high strength metallic member and a nonmetallic member in an arrangement wherein a difference in fluid pressures across the joint provides compressive force upon the girdle. Composite joints of the invention are particularly useful for joining a high strength metallic conduit and a gas-tight ceramic member wherein the ceramic member has a tubular structure, closed at one end, with a tapered mating surface at a distal end thereof and the mating surface is contiguous with a portion of the girdle.

Processes beneficially using joints in accordance with the invention include converting methane gas into value-added-products, for example, production of synthesis gas comprising carbon monoxide and molecular hydrogen. Advantageously, the synthesis gas is free of deleterious and/or inert gaseous diluents such as nitrogen.

### BACKGROUND OF THE INVENTION

Joints resistant to fluid leakage for gas-tight members that exhibit different coefficients of thermal expansion are required in certain processes that operate at high temperatures, generally, in chemically active environments. Such joints are useful, for example, in high temperature ceramic heat exchangers, candle filters, fuel cells, and ceramic membrane reactors for selective separations and/or chemical conversions. A persistent problem in design, operation and maintenance of such apparatus is that ceramic and rigid metal members typically exhibit different coefficients of thermal expansion, which can cause excessive fluid leakage through the joint, even fracture of the ceramic members, due to mechanical stresses during heating and cooling of the reactors.

A useful class of dense ceramic materials exhibits the ability to selectively separate a component from a gaseous mixture, for instance, oxygen from air. Membranes of such dense ceramic are gas tight and function at operating temperatures by allowing ions to selectively migrate through the membrane. The flux of ions is charged compensated by a counter flux of electronic charge carriers through the ceramic membrane. Disassociation and/or ionization of the selected molecules occurs at a membrane surface where the selected molecules acquire electrons from near surface electronic states. Ions arriving at the opposite side of the membrane release their electrons and recombine to form gas molecules. Differential partial pressure of the selected component and/or an external source of electric potential applied across the membrane typically provide a driving force for such transport.

Apparatus for advantageous use of dense ceramic membranes, as well as other nonmetallic materials such as glass, porcelain and the like, often must include joints with metallic materials. Since known dense ceramic materials exhibit a desired flux of ions at elevated temperatures, generally in the range upward from about 500° or 600° to about 1000° C. and higher, joints between ceramic and metal reactor parts are subjected to extreme environmental conditions. Critical to successful use of such dense ceramic materials are both survival of the ceramic membranes and adequate sealing at a plurality of locations where ceramic parts are joined with metal reactor parts. The invention disclosed below and defined by the claims that follow provides joints resistant to fluid leakage for such high-temperature applications, in particular for use in the operation of ceramic membrane reactor systems.

A major obstacle in developing viable joints is the unique mechanical properties of ceramic materials, e.g., high coefficients of thermal expansion and limited strength at the high operational temperatures of the membranes. Both factors prohibit the use of common fixed joining techniques such as welding or brazing. Instead, joining techniques that do not rigidly affix the ceramic within the reactor are used, e.g., non-bonding, compression type joint assembles.

U.S. Pat. No. 5,820,655 in the names of Gottzmann, Prasad, Bergsten, Keskar, and van Hassel, describes a solid electrolyte ionic conductor reactor design as using either a sliding or fixed seal with a bellows at the juncture of the ceramic membrane and metal reactor parts.

U.S. Pat. No. 4,917,302 in the names of Bruce M. Steinetz and Paul J. Sirocky describes high temperature seals that are used to seal structural panels. A stack of ceramic wafers located within a rectangular groove along the side of a movable engine panel. The engine panel is sealed to an adjacent side wall by the ceramic wafers which are held in position by a pressurized linear bellows that also fits within the groove. In U.S. Pat. No. 5,082,293 the same inventors show a similar seal except that the sealing element is made up of multiple layers of a fiber wound about a core. The materials for such fibers can be alumina-boriasilicate or silicon-carbide.

U.S. Pat. No. 5,301,595 in the name of Andrew S. Kessie describes a rope seal type joint packing having a core of ceramic fibers and a cover of stainless steel for high temperature environments such as in gas turbine engines. The rope seal is seated within a groove in one component and bears against a flat wall of another component. U.S. Pat. No. 4,394,023 in the name of Alberto L. Hinojosa describes a high temperature valve stem packing that incorporates graphite seal rings composed of coiled graphite tape held between metal packing adapter rings that bear against the graphite seal rings.

U.S. Pat. No. 5,401,406 discloses a seal for a filter element to connect the filter element to a tube-sheet. The filter element has an enlarged end that fits within a second passageway of the tube-sheet. A disc-like element bears against compressible, sealing material located at the open end of the filter element and between the filter element and the tube-sheet. The disc-like element is attached to the tube-sheet, by means such as by welding, to function as a hold down element to hold the filter element in place, sealed against the tube-sheet and sealed against the hold down element.

All of the foregoing describes devices that, when used for sealing ceramics to metal reactor parts, require some mechanical arrangement designed to hold the ceramic in place. Several such mechanical arrangements to hold the ceramic membrane in place and utilize high temperature sealing materials have been proposed. See for example U.S. Pat. No. 6,302,402; 6,454,274 or 6,547,286. Typically, the mechanical arrangements described are adapted from well-known apparatus used for rotating and/or reciprocating cylindrical shafts, such as are found in valve stems, gas turbines, reciprocating steam engines, positive displacement pumps, and the like. Gasket or packing material is compressed between a ceramic conduit and metal support by adjustment of the mechanical apparatus.

In all of these foregoing references, the seal between the tubular ceramic element and the tube-sheet, the ceramic-to-metal seal, is produced during assembly of the ceramic elements and the tube-sheet. As mentioned above, it is difficult to make reliable ceramic-to-metal seals in the first instance. This sealing problem becomes particularly troublesome when many tubular ceramic elements are to be attached to a tube-sheet. For instance, during assembly, when long ceramic elements are maneuvered into proper position relative to the tube-sheet, great care must be taken to not damage the ceramic elements while at the same time effecting a seal at each juncture of the ceramic elements and the tube-sheet. Furthermore, such assembly only allows for the testing of the ceramic-to-metal seal after assembly. If there are defective seals, individual elements must be removed and reassembled.

Accordingly, there remains a need for improved devices joining gas-tight members that exhibit different coefficients of thermal expansion, and overcome one or more of the problems described above.

It is desirable for any improved joining device to employ few individual elements, particularly, mechanical elements that often require adjustment and/or reassembly.

More particularly, there is a need for composite joints resistant to fluid leakage for membrane reactors that include a gas-tight ceramic having a composition that exhibits ionic and electronic conductivity as well as appreciable oxygen permeability at elevated temperatures.

Advantageously, an improved joining device should employ few individual elements, be self-sealing under condition of operation, and exhibits greater stability when exposed to a reducing gas environment and other operating conditions for extended time periods.

Other beneficial aspects of the invention will become apparent upon reading the following detailed description and appended claims.

### SUMMARY OF THE INVENTION

In broad aspect, the present invention is directed to joints that use a differential in fluid pressures from a low pressure side to high pressure side at the joint to provide compressive force upon a girdle disposed between and contiguous with mating surfaces of two rigid members that typically exhibit different coefficients of thermal expansion. In leak free joints according to the invention, the girdle beneficially, is a monolithic structure.

More particularly, in one aspect this invention provides a joint which comprises a girdle of a metallic material capable of undergoing deformation without rupture that is disposed between and contiguous with tapered mating surfaces of a first rigid member and a second rigid member, wherein differential pressure across the joint provides compressive force upon the girdle through the mating surfaces. Resistance to fluid leakage through the joint is thereby improved. Such joints resistant to fluid leakage advantageously are used for membrane reactors converting, for example, natural gas to synthesis gas by controlled partial oxidation and reforming reactions, and when desired subsequent conversion of the synthesis gas to added-value products, for example, by a water-gas shift process. Generally, in joints according to the invention the first rigid member comprises a nonmetallic material selected from the group consisting of glass, porcelain, and ceramic, and the second rigid member comprises a high strength metallic material capable of being welded, such as high-chromium ferritic steels and iron-chromium-aluminum alloys.

In one aspect of the invention, the first rigid member includes a ceramic material comprising a crystalline mixed metal oxide which at operating temperatures exhibits electron conductivity, oxygen ion conductivity, and ability to separate oxygen from a gaseous mixture containing oxygen and one or more other components by means of the conductivities.

In another aspect of the invention, the first rigid member has a tubular structure closed at one end with a tapered outer surface at a distal end of the rigid member that tapered surface is contiguous with a portion of the girdle. As used herein the degree angle of taper is measured from the axis of the tube. Any angle of taper suitable for the mechanical requirements of the application may be employed. Broadly, the angle of taper is in a range from about 1 to about 45 degrees. For ceramic to metallic joints according to the invention the angle of taper is for example in a range from about 1 to about 25 degrees, in particular applications from about 1.5 to about 15 degrees, and other applications the angle of taper is in a range from about 2 to about 10 degrees for best results.

Another aspect of this invention provides a joint which comprises a tubular member, optionally closed at one end, with a tapered outer surface at one or both open distal ends thereof comprising a nonmetallic material selected from the group consisting of glass, porcelain, and ceramic; a hollow girdle having a tapered inner surface adapted to support the tapered outer surface of the tubular member, the hollow girdle comprising a metallic material capable of undergoing plastic deformation without rupture; and a rigid member having an orifice adapted to support the hollow girdle, the rigid member comprising a high strength metallic material capable of being welded. Differential pressure across the joint or a mechanical means provides compressive force upon the girdle thereby forming and maintaining a joint resistant to fluid leakage. The nonmetallic material of the first rigid member and the high strength metallic material contiguous with the girdle typically exhibit different coefficients of thermal expansion.

In another aspect this invention provides a joint, which comprises a composite girdle comprising two or more materials at least one of which materials is capable of undergoing deformation without rupture, a conduit comprising a metallic material capable of being welded with an inner tapered surface at a distal end thereof adapted to mate with an outer surface of the girdle, and a hollow ceramic member having at least one opening for flow communication with the conduit and an outer tapered surface adjacent to the opening adapted to mate with an inner surface of the girdle, wherein a differential pressure across the joint provides compressive force upon the girdle through the mating surfaces.

According to the invention the joint may advantageously further comprise a mechanical means that provides compressive force upon the girdle through the mating surfaces.

Particularly useful are joints according to the invention wherein the ceramic member comprises a crystalline mixed metal oxide composition selected from a class of materials that have an X-ray identifiable crystalline structure based upon the structure of the mineral perovskite, CaTiO₃. A beneficial feature of such selectively permeable material is that it retain its ability to separate and transport oxygen for an adequate period of time.

The conduit advantageously comprises a high temperature alloy of at least one metallic element selected from the group consisting of aluminum, titanium, vanadium, chromium, iron, cobalt, nickel, molybdenum, and tungsten. In one aspect of the invention, the girdle has a monolithic structure comprising at least one metallic element selected from the group consisting of aluminum, copper, zinc, palladium, silver, tin, antimony, platinum, gold, lead and bismuth. For best results at elevated temperatures, the composite girdle comprises at least one metallic element selected from the group consisting of palladium, silver, platinum and gold.

Advantageously, a composite girdle according to the invention may comprise graphite imbedded in a metallic material capable of undergoing plastic deformation without rupture that is disposed between and contiguous with the tapered mating surfaces.

In another aspect of the invention, the girdle has a monolithic structure which comprises graphite with a coating of at least one metallic element selected from the group consisting of palladium, silver, platinum and gold, disposed to contact fluid on at least one side of the joint.

In yet another aspect of the invention the girdle comprises graphite that optionally has a coating of at least one metallic element selected from the group consisting of palladium, silver, platinum and gold that is disposed between and contiguous with the tapered mating surfaces for best results at elevated temperatures.

The invention also includes use of the joints according to the invention in membrane reactors for separation of oxygen from an oxygen-containing gaseous mixture. Typically in such processes the aforesaid dense ceramic membrane comprising a crystalline mixed metal oxide which exhibits, at operating temperatures, electron conductivity, oxygen ion conductivity, and ability to separate oxygen from a gaseous mixture containing oxygen and one or more other components by means of the conductivities are used in separation apparatus for transfer of oxygen from an oxygen-containing first gaseous mixture having a relatively higher oxygen partial pressure to a second gaseous mixture having a relatively lower oxygen partial pressure and preferably containing one or more components, more preferably including organic compounds that react with oxygen. An essential feature of such selectively permeable dense ceramic membrane of the composite materials is that it retain its ability to separate oxygen for an adequate period of time at the conditions of operation.

Particularly useful are processes according to the invention wherein the gaseous composition having a relatively lower oxygen partial pressure contains one or more organic compounds, and at least one of the organic compounds is reacted with the oxygen transported through the membrane to form oxidation products at temperatures in a range from about 500° C. to about 1150° C.

In yet another aspect, the invention provides a process to convert organic compounds into value-added products, which process comprises: providing a membrane reactor comprising a plurality of joints according to an aspect of the invention wherein the ceramic member comprises a dense ceramic membrane comprising a crystalline mixed metal oxide that exhibits, at operating temperatures, electron conductivity, oxygen ion conductivity, and ability to separate oxygen from a gaseous mixture containing oxygen and one or more other components by means of the conductivities; maintaining, at low pressure, a flow into the hollow ceramic member through the hollow girdle of an oxygen-containing gaseous mixture having a relatively high oxygen partial pressure; contacting, at high pressure, the outer surface of the hollow ceramic member with a gaseous composition having a relatively lower oxygen partial pressure; and; permitting oxygen to be transported through the dense ceramic membrane by means of its electron conductivity and oxygen ion conductivity thereby separating oxygen from the oxygen-containing gaseous mixture having a relatively higher oxygen partial pressure into the gaseous composition having a relatively lower oxygen partial pressure.

Particularly useful are processes according to the invention wherein the dense ceramic membrane permeable to oxygen comprises a crystalline mixed metal oxide composition represented by
(D_{1-y}M′_{y})_{α}(E₁₋ₓGₓ)_{α+β}O_{δ}
where D is a metal selected from the group consisting of magnesium, calcium, strontium, and barium, M is a metal selected from the group consisting of magnesium, calcium, strontium, barium, copper, zinc, silver, cadmium, gold, mercury, yttrium, lanthanum and the lanthanides, E is an element selected from the group consisting of vanadium, chromium, manganese, iron, cobalt, and nickel, G is an element selected from the group consisting of vanadium, chromium, manganese, iron, cobalt, nickel, niobium, molybdenum, technetium, ruthenium, rhodium, palladium, indium, tin, antimony, rhenium, lead, zirconium, lanthanides and bismuth, with the proviso that D, E, G and M′ are different elements, y is a number in a range from about zero to about one, x is a number in a range from about zero to about one, α is a number in a range from about 0.1 to about 4, β is a number in a range from 0 to about 20, with the proviso that
1≦(α+β)/α≦6,
and δ is a number which renders the compound charge neutral.

In one aspect of the invention, the gaseous composition having a relatively lower oxygen partial pressure contains one or more organic compounds selected from the group consisting methanol, dimethyl ether, ethylene oxide, and hydrocarbons containing 1 to about 20 carbons, and the reaction products include synthesis gas comprising carbon monoxide and molecular hydrogen.

The gaseous composition having a relatively lower oxygen partial pressure advantageously is maintained at total pressure in a range upward from total pressure of the oxygen-containing gaseous mixture to obtain the differential pressures of at least 15 pounds per square inch across the joint which thereby provides compressive force upon the girdle through the mating surfaces. Preferably, differential pressures across the joint are in a range upward from atmospheric to about 450 pounds per square inch.

In yet another aspect of the invention, the dense ceramic membrane permeable to oxygen comprises the crystalline mixed metal oxide composition represented by
La_{0.2}Sr_{0.8}Fe_{0.8}Cr_{0.2}O_{3-δ}
where δ is a number that renders the compound charge neutral.

Particularly useful are processes according to the invention wherein the gaseous composition having a relatively lower oxygen partial pressure contains one or more organic compounds, and reacting at least one of the organic compounds with the oxygen transported through the membrane to form oxidation products at temperatures in a range from about 500° C. to about 1150° C. More particularly, the gaseous composition having a relatively lower oxygen partial pressure comprises methane, and the reaction products include synthesis gas comprising carbon monoxide and molecular hydrogen.

### BRIEF DESCRIPTION OF THE DRAWINGS

The appended claims set forth those novel features which characterize the present invention. The present invention itself, as well as advantages thereof, may best be understood, however, by reference to the following brief description of preferred embodiments taken in conjunction with the annexed drawings, in which:

FIG. 1, which comprises FIG. 1-a and FIG. 1-b, shows elevation views of two joint assemblies of the present invention.

FIG. 2 is a graph showing differential pressure performance during many thermal cycles versus time for a leak free joint of the invention.

FIG. 3 is a graph showing oxygen flux performance and methane conversion versus time under syngas process conditions after the thermal cycles for a leak free joint of the invention.

FIG. 4 is a graph showing the positive relationship of oxygen flux with differential pressure versus time under syngas process conditions after the thermal cycles for a leak free joint of the invention.

FIG. 5 is a graph showing a decreasing relationship of oxygen flux versus differential pressure with a neat helium sweep on the high pressure side of the oxygen transfer membrane.

FIG. 6 is a graph showing formation of a robust joint according to the invention by increasing temperature and differential pressure over time.

FIG. 7 is a graph showing oxygen flux versus air side entrance flow rate under syngas process conditions of 1000° C. and 390 psid using a leak free joint of the invention.

FIG. 8 is a graph showing percentage oxygen utilization versus air side entrance flow rate under syngas process conditions of 1000° C. and 390 psid using a leak free joint of the invention.

For a more complete understanding of the present invention, reference should now be made to the embodiments illustrated in greater detail in the accompanying drawing and described below by way of examples of the invention.

### BRIEF DESCRIPTION OF THE INVENTION

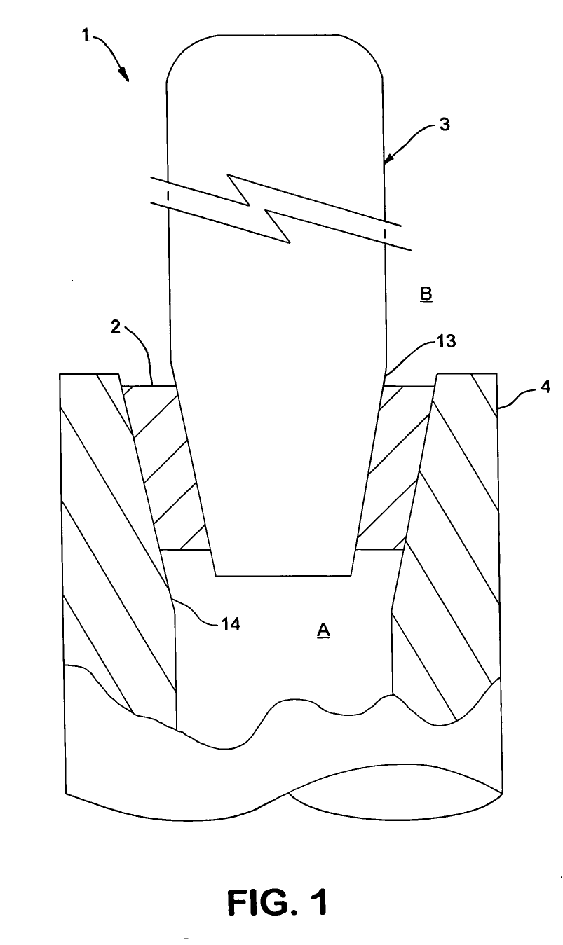

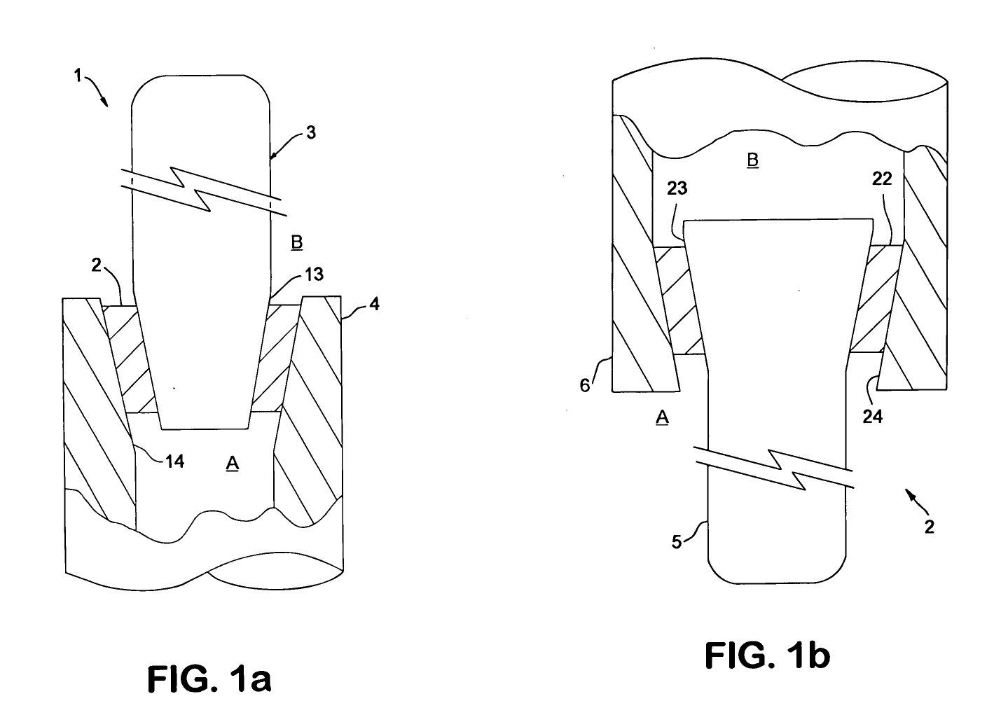

With reference to FIG. 1, two joints resistant to fluid leakage in accordance with the present invention are illustrated. As shown in FIG. 1-a, Joint 1 serves to connect two hollow members for flow communication therebetween while isolating side “A” of the joint from the opposite side “B” of the joint. Girdle 2, illustrated in section, is a monolithic structure consisting of a material capable of undergoing deformation without rupture. A first rigid member 3 is illustrated as a tubular structure closed at one end with a tapered outer mating surface 13 at a distal end thereof. A second rigid member 4 is illustrated in partial section with an inner mating surface 14. Girdle 2 is disposed between and contiguous with mating surface 13 of rigid member 3 and mating surface 14 of rigid member 4. Differential pressure across the joint, from side “B” to side “A”, provides compressive force upon the girdle through the mating surfaces thereby improving resistance to fluid leakage through the joint. Advantageously, the second rigid member comprises a high strength metallic material capable of being welded. Beneficially, the first rigid member comprises a nonmetallic material, for example, a glass, porcelain, or ceramic.

As shown in FIG. 1-b, Joint 2 serves to connect two hollow members for flow communication therebetween while isolating side “A” of the joint from the opposite side “B” of the joint. Girdle 22, illustrated in section, is a monolithic structure consisting of a material capable of undergoing plastic deformation without rupture for best results. A first rigid member 5 is illustrated as a tubular structure closed at one end with a tapered outer mating surface 23 at a distal end thereof. A second rigid member 6 is illustrated in partial section with an inner mating surface 24. Girdle 22 is disposed between and contiguous with mating surface 23 of rigid member 5 and mating surface 24 of rigid member 6. Differential pressure across the joint, from side “B” to side “A”, provides compressive force upon the girdle through the mating surfaces thereby improving resistance to fluid leakage through the joint.

Joints as described above are useful for joining two dissimilar materials in many types of chemical processes. For example, such joints are particularly suitable for high temperature chemical conversion using dense ceramic membranes. As stated previously, dense ceramic membranes useful in accordance with this invention typically comprises a crystalline mixed metal oxide which exhibits, at operating temperatures, electron conductivity, oxygen ion conductivity and ability to separate oxygen from a gaseous mixture containing oxygen and one or more other volatile components by means of the conductivities.

Conversion of low molecular weight alkanes, such as methane, to synthetic fuels or chemicals has received increasing attention as low molecular weight alkanes are generally available from secure and reliable sources. For example, natural gas wells and oil wells currently produce vast quantities of methane. In addition, low molecular weight alkanes are generally present in coal deposits and may be formed during mining operations, in petroleum processes, and in the gasification or liquefaction of coal, tar sands, oil shale, and biomass.

Many of these alkane sources are located in relatively remote areas, far from potential users. Accessibility is a major obstacle to effective and extensive use of remotely situated methane, ethane and natural gas. Costs associated with liquefying natural gas by compression or, alternatively, constructing and maintaining pipelines to transport natural gas to users are often prohibitive. Consequently, methods for converting low molecular weight alkanes to more easily transportable liquid fuels and chemical feedstocks are desired and a number of such methods have been reported.

Reported methods can be conveniently categorized as direct oxidation routes and/or as indirect syngas routes. Direct oxidative routes convert lower alkanes to products such as methanol, gasoline, and relatively higher molecular weight alkanes. In contrast, indirect syngas routes involve, typically, production of synthesis gas as an intermediate.

As is well known in the art, synthesis gas (“syngas”) is a mixture of carbon monoxide and molecular hydrogen, generally having a dihydrogen to carbon monoxide molar ratio in the range of 1:5 to 5:1, and which may contain other gases such as carbon dioxide. Synthesis gas has utility as a feedstock for conversion to alcohols, olefins, or saturated hydrocarbons (paraffins) according to the well-known Fischer-Tropsch process, and by other means. Synthesis gas is not a commodity; rather, it is typically generated on-site for further processing. At a few sites synthesis gas is generated by a supplier and sold “over the fence” for further processing to value added products. One potential use for synthesis gas is as a feedstock for conversion to high molecular weight (e.g., C₅₀₊) paraffins that provide an ideal feedstock for hydrocracking for conversion to high quality jet fuel and superior high cetane value diesel fuel blending components. Another potential application of synthesis gas is for large scale conversion to methanol.

In order to produce high molecular weight paraffins in preference to lower molecular weight (e.g., C₈ to C₁₂) linear paraffins, or to synthesize methanol it is desirable to utilize a synthesis gas feedstock having an H₂:CO molar ratio of about 2.1:1, 1.9:1, or less. As is well known in the art, Fischer-Tropsch syngas conversion reactions using syngas having relatively high H₂:CO ratios produce hydrocarbon products with relatively large amounts of methane and relatively low carbon numbers. For example. With an H₂:CO ratio of about 3, relatively large amounts of C1-C8 linear paraffins are typically produced. These materials are characterized by very low octane value and high Reid vapor pressure, and are highly undesirable for use as gasoline.

Lowering the H₂:CO molar ratio alters product selectivity by increasing the average number of carbon atoms per molecule of product, and decreases the amount of methane and light paraffins produced. Thus, it is desirable for a number of reasons to generate syngas feedstocks having molar ratios of hydrogen to carbon monoxide of about 2:1 or less.

Prior methods for producing synthesis gas from natural gas (typically referred to as “natural gas reforming”) can be categorized as; (a) those relying on steam reforming where natural gas is reacted at high temperature with steam, (b) those relying on partial oxidation in which methane is partially oxidized with pure oxygen by catalytic or non-catalytic means, and (c) combined cycle reforming consisting of both steam reforming and partial oxidation steps.

Steam reforming involves the high temperature reaction of methane and steam over a catalyst to produce carbon monoxide and hydrogen. This process, however, results in production of syngas having a high ratio of hydrogen to carbon monoxide, usually in excess of 3:1.

Partial oxidation of methane with pure oxygen provides a product that has an H₂:CO ratio close to 2:1, but large amounts of carbon dioxide and carbon are co-produced, and pure oxygen is an expensive oxidant. An expensive air separation step is required in combined cycle reforming systems, although such processes do result in some capital savings since the size of the steam reforming reactor is reduced in comparison to a straightforward steam reforming process.

Although direct partial oxidation of methane using air as a source of oxygen is a potential alternative to today's commercial steam-reforming processes, downstream processing requirements cannot tolerate nitrogen (recycling with cryogenic separations is required), and pure oxygen must be used. The most significant cost associated with partial oxidation is that of the oxygen plant. Any new process that could use air as the feed oxidant and thus avoid the problems of recycling and cryogenic separation of nitrogen from the product stream will have a dominant economical impact on the cost of a syngas plant, which will be reflected in savings of capital and separation costs.

Thus, it is desirable to lower the cost of syngas production as by, for example, reducing the cost of the oxygen plant, including eliminating the cryogenic air separation plant, while improving the yield as by minimizing the co-production of carbon, carbon dioxide and water, in order to best utilize the product for a variety of downstream applications.

Dense ceramic membranes represent a class of materials that offer potential solutions to the above-mentioned problems associated with natural gas conversion. Certain ceramic materials exhibit both electronic and ionic conductivities (of particular interest is oxygen ion conductivity). These materials not only transport oxygen (functioning as selective oxygen separators), but also transport electrons back from the catalytic side of the reactor to the oxygen-reduction interface. As such, no external electrodes are required, and if the driving potential of transport is sufficient, the partial oxidation reactions should be spontaneous. Such a system will operate without the need of an externally applied electrical potential. Although there are recent reports of various ceramic materials that could be used as partial oxidation ceramic membrane, little work appears to have been focused on the problems associated with the stability of the material under methane conversion reaction conditions.

Materials known as “perovskites” are a class of materials that have an X-ray identifiable crystalline structure based upon the structure of the mineral perovskite, CaTiO₃. In its idealized form, the perovskite structure has a cubic lattice in which a unit cell contains metal ions at the corners of the cell, another metal ion in its center and oxygen ions at the midpoints of each cube edge. This cubic lattice is identified as an ABO₃-type structure where A and B represent metal ions. In the idealized form of perovskite structures, generally, it is required that the sum of the valences of A ions and B ions equal 6, as in the model perovskite mineral, CaTiO₃.

A variety of substitutions of the A and B cations can occur. Replacing part of a divalent cation by a trivalent cation or a pentavalent ion for a tetravalent ion, i.e., donor dopant, results in two types of charge compensation, namely, electronic and ionic, depending on the partial pressure of oxygen in equilibrium with the oxides. The charge compensation in acceptor-doped oxides, i.e., substituting a divalent cation for a trivalent cation is by electronic holes at high oxygen pressures but at low pressures it is by oxygen ion vacancies. Ion vacancies are the pathway for oxide ions. Therefore, the oxygen flux can be increased by increasing the amount of substitution of lower valence element for a higher valence metal ion. The reported oxygen flux values in perovskites tend to follow the trends suggested by the charge compensation theory. While the primary property of high oxygen flux appears to be feasible in a few combinations of dopants in ABO₃-type oxides, many other questions need to be answered about the ideal material for constructing a novel membrane reactor. For example, the mechanical properties of the chosen membrane must have the strength to maintain integrity at the conditions of reaction. It must also maintain chemical stability for long periods of time at the reaction conditions. The oxygen flux, chemical stability, and mechanical properties depend on the stoichiometry of the ceramic membrane.

Many materials having the perovskite-type structure (ABO₃-type) have been described in recent publications including a wide variety of multiple cation substitutions on both the A and B sites said to be stable in the perovskite structure. Likewise, a variety of more complex perovskite compounds containing a mixture of A metal ions and B metal ions (in addition to oxygen) are reported. Publications relating to perovskites include: P. D. Battle et al., J. Solid State Chem., 76,334 (1988); Y. Takeda et al., Z Anorg. Allg. Chem., 550/541, 259 (1986); Y. Teraoka et al., Chem. Lett., 19, 1743 (1985); M. Harder and H. H. Muller-Buschbaum, Z Anorg. Allg. Chem., 464, 169 (1980); C. Greaves et al., Acta Cryst., B31, 641 (1975).

The design and operation of high temperature mixed conductor membrane reactor systems for the production of oxygen, synthesis gas, and other hydrocarbon products will utilize tubular geometry within the reactor modules and for piping connections to the reactor modules for feed and product gas flow. Ceramic-to-metal seals are required in these reactor systems to segregate feed and product gases at elevated process temperatures in the range of 500° C. to 1000° C. Such seals must be able to cycle between ambient temperature and operating temperature while segregating gases with elevated pressure differentials across the seals.

Ceramic powders with varying stoichiometry are made by solid-state reaction of the constituent carbonates and nitrates. Appropriate amounts of reactants are, generally, mixed and milled in methanol using zirconia media for several hours. After drying, the mixtures are calcined in air at elevated temperatures, e.g., up to about 850° C. for several hours, typically, with an intermittent grinding. After the final calcination, the powder is ground to small particle size. The morphology and particle size distribution can play a significant role during the fabrication of membrane tubes.

Membrane tubes can be conveniently fabricated by known methods of plastic extrusion. To prepare for extrusion, ceramic powder is, generally, mixed with several organic additives to make a formulation with enough plasticity to be easily formed into various shapes while retaining satisfactory strength in the green state. This formulation, known as a slip, consists in general of a solvent, a dispersant, a binder, a plasticizer, and ceramic powder. The role of each additive is described in Balachandran et al., Proceedings International Gas Research Conference, Orlando, Fla. (H. A. Thompson editor, Government Institutes, Rockville, Md.), pp. 565-573 (1992). Ratios of the various constituents of a slip vary, depending on the forming process and such characteristics of the ceramic powder as particle size and specific surface area. After the slip is prepared, some of the solvent is allowed to evaporate; this yields a plastic mass that is forced through a die at high pressure (about 20 MPa) to produce hollow tubes. Tubes have been extruded with outside diameter of about −6.5 mm and lengths up to about 30 cm. The wall thicknesses are in the range 0.25 to 1.20 mm. In the green state (i.e., before firing), extruded tubes exhibit great flexibility.

Extruded or isostaticaly pressed tubes are heated in flowing air at a slow heating rate (5° C. per hour) to temperatures in range of 150° to about 400° C. to facilitate removal of gaseous species formed during decomposition of organic additives. After the organics are removed at low temperatures, the heating rate is increased to about 60° C. per hour, and the tubes are sintered in flowing nitrogen at temperatures in range of about 1200° to about 1400° C. for 5 to 10 hours. Performance characteristics of the membranes depend on the stoichiometry of the compound.

Particularly useful crystalline mixed metal oxide compositions are selected from a class of materials represented by
D₆₀ E_{α+β}O_{δ}
where D comprises at least one metal selected from the group consisting of magnesium, calcium, strontium, lanthanum, and barium, E comprises at least one element selected from the group consisting of vanadium, chromium, manganese, iron, cobalt, and nickel, α is a number in a range from about 0.7 to about 4, β is a number in a range from zero to about 20, with the proviso that
1≦(α+β)/α≦6,
and δ is a number which renders the compound charge neutral.

Dense ceramic membranes used in accordance with this invention advantageously and preferably comprise a crystalline mixed metal oxide composition that has a crystalline structure comprising layers having a perovskite structure held apart by bridging layers having a different structure identifiable by means of powder X-ray diffraction pattern analysis. Such dense ceramic membranes exhibit electron conductivity and oxygen ion conductivity, and ability to separate oxygen from a gaseous mixture containing oxygen and one or more other volatile components by means of the conductivities.

Useful dense ceramic membranes advantageously comprise the crystalline mixed metal oxide composition is represented by
(D_{1-y}M′_{y})_{α}(E₁₋ₓGₓ)_{α+β}O_{δ}
where D is a metal selected from the group consisting of magnesium, calcium, strontium, lanthanum, and barium, M′ is a metal selected from the group consisting of magnesium, calcium, strontium, barium, copper, zinc, silver, cadmium, gold, mercury, yttrium, lanthanum and the lanthanides, Eis an element selected from the group consisting of vanadium, chromium, manganese, iron, cobalt, and nickel, G is an element selected from the group consisting of vanadium, chromium, manganese, iron, cobalt, nickel, niobium, molybdenum, technetium, ruthenium, rhodium, palladium, indium, tin, antimony, rhenium, lead, and bismuth, with the proviso that D, E, G and M′ are different elements, y is a number in a range from about zero to about one, x is a number in a range from about zero to about one, α is a number in a range from about 0.1 to about 4, β is a number in a range from 0 to about 20, with the proviso that
1≦(α+β)/α≦6,
and δ is a number that renders the compound charge neutral.

In other preferred aspects of the invention the crystalline mixed metal oxide composition is represented by
(Sr_{1-Y}M_{y})_{α}(Fe_{1-X}Cr_{X})_{α+β}O_{δ}
where and M is an element selected from the group consisting of yttrium, barium, and lanthanum, X is a number in a range from about 0.01 to about 0.95, preferably X is a number in a range from 0.01 to 0.99, Y is a number in a range from about 0.01 to about 0.99, preferably Y is a number in a range upward from 0.1 to about 0.5, a is a number in a range from about 0.7 to about 4, β is a number in a range from about zero to about 20, preferably β is a number in a range from about 0.1 to about 6, with the proviso that
1≦(α+β)/α≦6,
and δ is a number that renders the compound charge neutral.

In yet other preferred aspects of the invention the crystalline mixed metal oxide composition is represented by
La_{0.2}Sr_{0.8}Fe_{0.8}Cr_{0.2}O_{3-δ}
where δ is a number that renders the compound charge neutral, and wherein the composition has an X-ray identifiable crystalline structure based upon the structure of the mineral perovskite, CaTiO₃.

As is generally known, the assigned strengths in X-ray diffraction patterns may vary depending upon the characteristics of the sample. The observed line strength in any particular sample may vary from another sample, for example, depending upon the amounts of each crystalline phase, oxygen content, and/or amorphous material in a sample. Also, X-ray diffraction lines of a particular crystalline material may be obscured by lines from other materials present in a measured sample.

Useful crystalline mixed metal oxide compositions can, also, be selected from a class of materials known, generally, as perovskites that have an X-ray identifiable crystalline structure based upon the structure of the mineral perovskite, CaTiO₃. In its idealized form, the perovskite structure has a cubic lattice in which a unit cell contains metal ions at the corners of the cell, another metal ion in its center and oxygen ions at the midpoints of each cube edge. This cubic lattice is identified as an ABO₃-type structure where A and B represent metal ions. In the idealized form of perovskite structures it is required that the sum of the valences of A ions and B ions equal 6, as in the model perovskite mineral, CaTiO₃.

Preferred membranes include an inorganic crystalline material comprising strontium, iron, cobalt and oxygen, preferably having an X-ray identifiable crystalline structure based upon the structure of the mineral perovskite, CaTiO₃. Advantageously the crystalline mixed metal oxide demonstrates oxygen ionic conductivity and electronic conductivity. The invention includes methods for preparation of crystalline mixed metal oxide compositions containing strontium, cobalt, iron and oxygen with and without other elements.

As mentioned above, the mixed metal oxide materials useful in dense ceramic membranes of this invention include any single phase and/or multi-phase, dense phase, intimate mixture of materials that has electron conductivity and oxygen ion conductivity. In relation to the solid metal oxide materials, the terms “mixture” and “mixtures” include materials comprised of two or more solid phases, and single-phase materials in which atoms of the included elements are intermingled in the same solid phase, such as in the yttria-stabilized zirconia. The term “multi-phase” refers to a material that contains two or more solid phases interspersed without forming a single phase solution. Useful core material, therefore, includes the multi-phase mixture which is “multi-phase” because the electronically conductive material and the oxygen ion-conductive material are present as at least two solid phases, such that atoms of the various components of the multi-component solid are, primarily, not intermingled in the same solid phase.

Useful multi-phase solid core materials are described in European Patent Application number; 90305684.4, published on Nov. 28, 1990, under Publication No. EP 0 399 833 A1 the disclosure of which is hereby incorporated herein by reference.

In the indirect method for making a dense ceramic membranes containing a mixed metal oxide material having crystalline structure according to the invention, a solid oxide is made and commuted to a powder, the powder is blended into a plastic mass with solvent liquid and optionally additives, a desired shape formed from the plastic mass, and the shape heated to temperatures sufficient to form a dense and solid ceramic having electron conductivity and oxygen ion conductivity. Typically, such ceramics are obtained at temperatures in a range upward from about 500° C., and generally at temperatures in a range upward from about 800° C.

High strength metallic materials for use according to this invention can be made of any suitable alloy that exhibits mechanical stability at operating temperature. Particularly useful are alloys, such as nickel-base steel alloys. Suitable, commercially available, high strength metallic materials include INCONEL 601 nickel-chromium-aluminum alloy, INCOLOY 800HT nickel-iron-chromium alloy, HAYNES 214 nickel-chromium-aluminum alloy, HAYNES 230 nickel-chromium alloy, iron-chromium-aluminum alloy formed with a fine distribution of yttrium oxide particles, other oxide dispersion strengthened (ODS) PM 1000, PM 2000 and PM 3030, for best performance at elevated temperatures.

The oxygen ion-conducting ceramic membrane provides a gas-tight partition. The ceramic is impervious to the components of the oxygen-containing gaseous mixture at ambient temperature. When an oxygen-containing gaseous mixture having a suitably high partial pressure of oxygen, i.e., in a range upward from about 0.2 atm., is applied to of a dense ceramic membrane of this type, oxygen will adsorb and dissociate on the surface, become ionized and diffuse through the ceramic to the other side and deionize, associate and desorb as separated oxygen into another gaseous mixture having a partial pressure of oxygen lower than that applied to the outer surface. The necessary circuit of electrons to supply this ionization/deionization process is, advantageously, maintained internally in the oxide via its electronic conductivity.

Oxygen-containing gaseous mixtures suitable as feed streams to the present process typically contain between about 10 mole percent to 50 mole percent oxygen. Water, carbon dioxide, nitrogen and/or other gaseous components are typically present in feed mixtures. A preferred oxygen-containing gaseous mixture is atmospheric air. Volatile hydrocarbons that are converted to carbon dioxide and water under operating conditions of the process may be included in small amounts without causing adverse effect on the separation process. Representative of such hydrocarbons are linear and branched alkanes, alkenes and alkynes having from 1 to about 8 carbon atoms.

A difference in partial pressure of oxygen between the first and second zones, i.e., across the membrane, provides the driving force for separation of oxygen from an oxygen-containing gaseous mixture at process temperatures sufficient to cause oxygen in the first zone to adsorb, become ionized on the first surface and be transported through the ceramic membrane in ionic form toward the second surface of the ceramic membrane and the second zone where partial pressure of oxygen is lower than the first zone. Transported oxygen is collected and/or reacted in the second zone wherein ionic oxygen is converted into neutral form by release of electrons at the second surface.

An excess partial pressure of oxygen in the first zone over that in the second zone (positive oxygen partial pressure difference) can be created by compressing the gaseous mixture in the first zone to a pressure sufficient to recover transported oxygen, i.e., an oxygen permeate stream, at a pressure of equal to or greater than about one atmosphere. Typical feed pressures are in a range of from about 15 psia to abut 250 psia, depending largely upon the amount of oxygen in the feed mixture. Conventional compressors can be utilized to achieve the compression required to practice the present process.

Alternatively, a positive oxygen partial pressure difference between the first and second zones can be achieved by reaction of transported oxygen with an oxygen-consuming substance, such as a volatile organic compound, to form value added oxygen-containing products and/or by mechanical evacuation of the second zone to a pressure sufficient to recover transported oxygen. Advantageously, a gaseous mixture containing organic compounds such as methane, ethane, and other light hydrocarbon gases, for example natural gas under well-head pressures of several hundred psi, is fed into the second zone wherein at least one of the compounds reacts with the oxygen transferred into the zone to form value added oxidation products.

Oxygen-containing gas steams which flow across the first surface of dense ceramic membranes in gas separation apparatus of this invention can be air, pure oxygen, or any other gas containing at least about 1 mol percent free oxygen. In another embodiment, the oxygen-containing gas stream contains oxygen in other forms such as N₂O, NO, SO₂, SO₃, steam (H₂O), CO₂, etc. Preferably, the oxygen-containing gas steam contains at least about 1 mol percent free molecular oxygen (dioxygen) and more preferably the oxygen-containing gas steam is air.

As mentioned above, processes according to the present invention include processes for preparing synthesis gas by reacting oxygen from an oxygen-containing gas stream with a hydrocarbyl compound in another gas stream without contaminating the hydrocarbyl compound and/or products of oxidation with other gases from the oxygen-containing gas stream, such nitrogen from an air stream. Synthesis gas, a mixture of carbon monoxide (CO) and molecular hydrogen (H₂), is a valuable industrial feedstock for the manufacture of a variety of useful chemicals. For example, synthesis gas can be used to prepare methanol or acetic acid. Synthesis gas can also be used to prepare higher molecular weight alcohols or aldehydes as well as higher molecular weight hydrocarbons. Synthesis gas produced by the partial oxidation of methane, for example, is an exothermic reaction and produces synthesis gas having a useful ratio of hydrogen to carbon monoxide, according to the following equation:

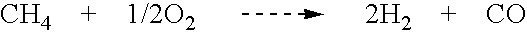

Preferred embodiments include processes for preparing synthesis gas by partial oxidation of any vaporizable hydrocarbyl compound. Hydrocarbyl compound used in processes of this invention suitably comprises one or more gaseous or vaporizable compounds that can be reacted with molecular oxygen or carbon dioxide to form synthesis gas. Most suitably, the hydrocarbyl compound is a hydrocarbon such as methane and/or ethane, however, various amounts of oxygen or other atoms can also be in the hydrocarbyl molecule. For example, hydrocarbyl compounds that can be converted to synthesis gas include methanol, dimethyl ether, ethylene oxide, and the like. However, the most preferable hydrocarbyl compounds are the low molecular weight hydrocarbons containing about 1 to about 20 carbons, more preferably 1 to about 10 carbon atoms. Methane, natural gas, which is mainly methane, or other light hydrocarbon mixtures that are readily available, inexpensive, are particularly preferred hydrocarbyl feed materials for processes of this invention. The natural gas can be either wellhead natural gas or processed natural gas. Composition of processed natural gas varies with the needs of the ultimate user. A typical processed natural gas composition contains, on a dry or water free basis, about 70 percent by weight of methane, about 10 percent by weight of ethane, 10 percent to 15 percent of CO₂, and the balance is made up of smaller amounts of propane, butane and nitrogen. Preferred hydrocarbyl feed materials also contain water at levels of about 15 percent which levels are useful to quench heat of any oxidation reactions. Mixtures of hydrocarbyl and/or hydrocarbon compounds can also be used.

### EXAMPLES OF THE INVENTION

The following Examples will serve to illustrate certain specific embodiments of the herein disclosed invention. These Examples should not, however, be construed as limiting the scope of the novel invention as there are many variations that may be made thereon without departing from the spirit of the disclosed invention, as those of skill in the art will recognize.

### Example 1

This example demonstrates preparation of a joint resistant to fluid leakage according to one aspect of the invention. A gas-tight ceramic comprising an oxygen transport material was fabricated in the form of a tube closed at one end (COE) and having a nominal outer diameter (OD) of 3/8 inch using an iso-static press with a pre-formed bag and mandrel. The ceramic tube had a tapered outer surface near its open end with a 3 degree angle of taper as measured from the axis of the tube. Except where otherwise noted, the tapered surface was polished with 350 grit grinding media in a hardened metal head resembling a pencil sharpener. This polishing is only optional, as an example below will illustrate. A girdle of cast gold was disposed between the tapered ceramic surface and a high strength metallic material (alloy) comprising HAYNES 230.

### Example 2

In this example, the joint described in Example 1 was tested over many thermal cycles at pressure differential across the membrane of from about 60 to about 180 pounds per square inch differential (psid).

The entire apparatus was placed in a pipe of HAYNES 230 alloy (nominal 1½″ diameter). A high pressure nitrogen purge rate was 4 L/min. on the fuel side of the membrane, and a low pressure nitrogen purge rate was 2 L/min. on the air side of the membrane. The pipe containing the apparatus was inserted into a furnace that has heated at a rate of 1.2° C. per minute to 975° C., and held at 975° C. during operation.

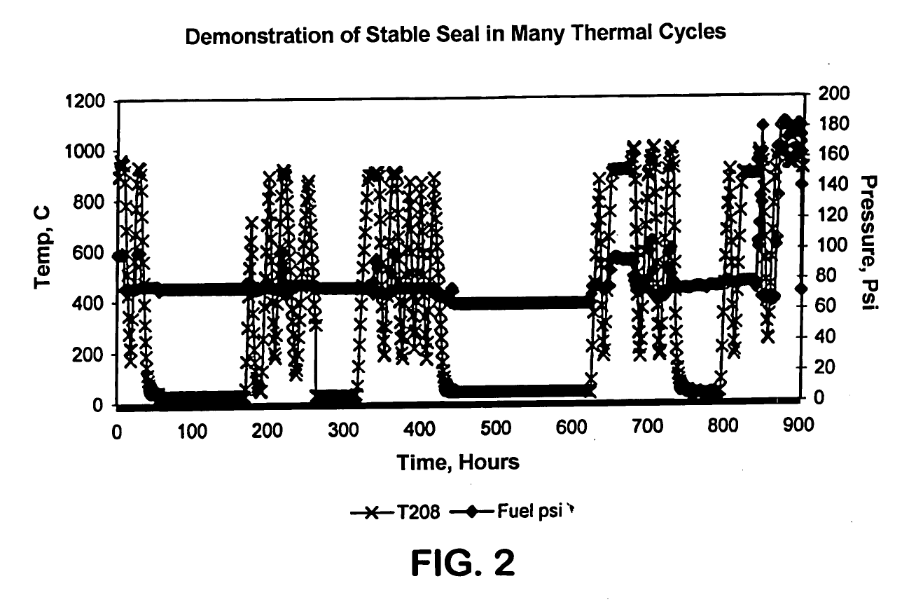

As shown in FIG. 2, the temperature was increased to 975° C. and then cooled between 20° C. and 200° C. The pressure in the reactor was maintained above 60 psid and as high as 180 psid. The pressure spikes were from increasing the pressure to operate under syngas process conditions. Therefore, each time the process gases of methane and steam were brought into the reactor, the pressure was also increased.

### Example 3

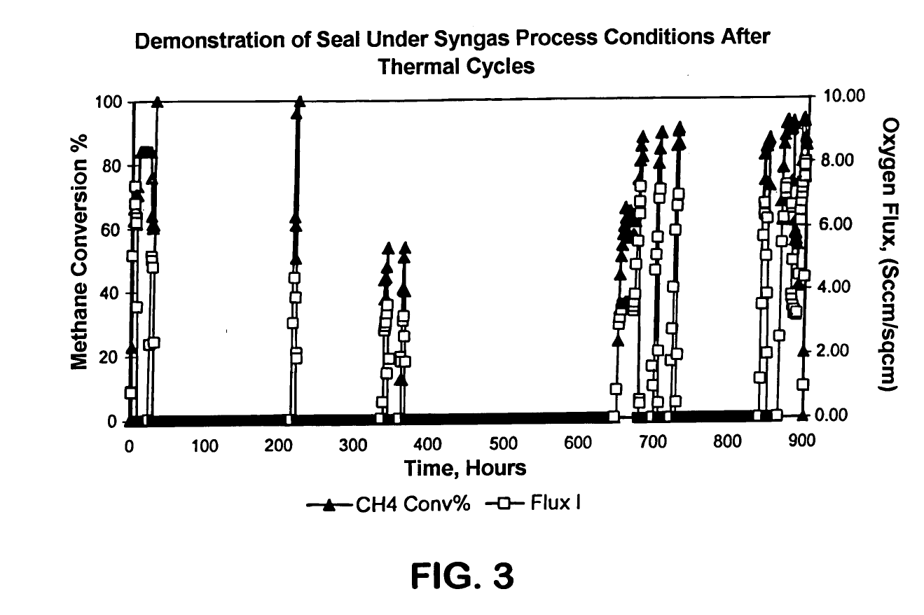

In this example, the joint and COE oxygen transport membrane described in Example 1 were demonstrated to under go syngas process cycles converting methane and steam at a ratio of 1 to 2 into syngas at near equilibrium conditions at about 975° C. to about 1000° C. The air side of the membrane was at near ambient pressure whereas the syngas side of the membrane was as high as 180 psid. As shown in FIG. 3, an oxygen Flux of 8 sccm/cm² was achieved. The leak tight seal allows the oxygen transport membrane to act as an oxygen compressor hence the membrane is 100 percent selective to oxygen transport. Any leakage through the joint could easily have been detected by a temperature rise as recorded with thermal couples placed on the air side of the membrane. The high-pressure methane fuel would burn with ambient pressure air. These temperatures can be very high which melt the seal, membrane, and metal holder. Typically carbon dioxide and moisture sensors were placed in the spent air to detect for leaks. In the case above, the sensors did not detect any carbon dioxide or moisture in the spent air exiting the membrane.

### Example 4

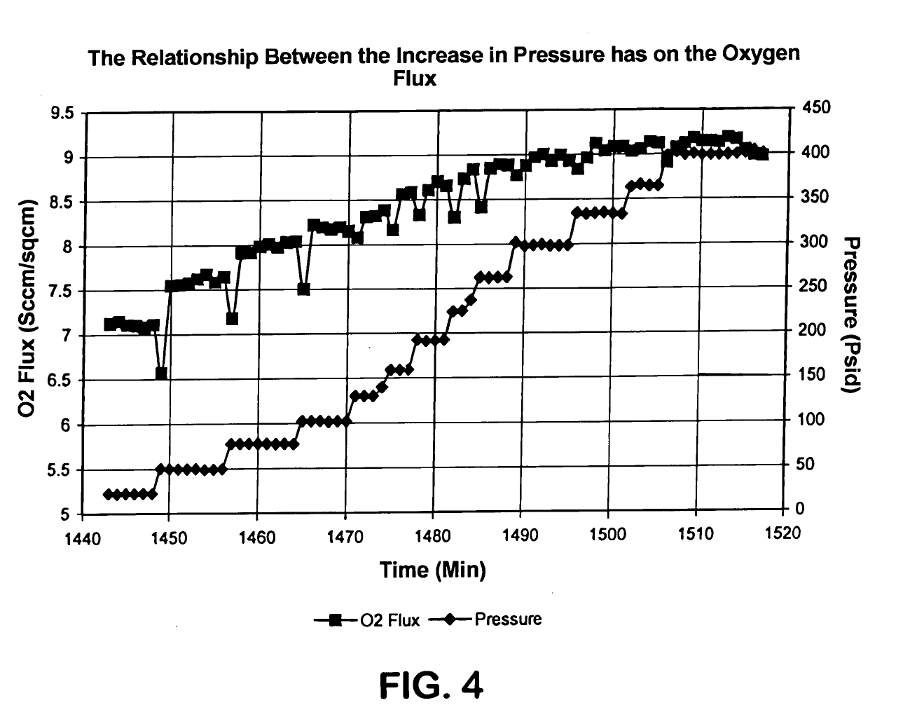

This example demonstrates an unexpected and unique relationship between the pressure and oxygen flux passing through the membrane. As shown in FIG. 4, the oxygen flux increased with increased differential gas pressure. The increase in oxygen flux with pressure was related to the enhancement of the surface exchange rate on the membrane surface. This demonstrated that the surface exchange rate on the fuel side of the membrane was the rate limiting step and not the ionic oxygen transfer through the bulk of the membrane. The concentration gradient of hydrogen and carbon monoxide increased with increasing pressure on the fuel side to remove more of the ionic oxygen species. Hence, an increase in the surface exchange rate was observed.

The small dips in the oxygen flux immediately following a pressure increase were related to the decrease of fuel flow over the membrane as the pressure increased. As a result the oxygen partial pressure increased on the fuel side and hence the oxygen flux dipped momentarily, but when the pressure had stabilized and gas flowed across the membrane, the oxygen flux increased up to about 9.2 sccm/cm² at 420 psid. The process conditions were; 0.7 L/min. of carbon dioxide and 2.8 L/min. of hydrogen on the fuel side of the La_{0.2} Sr_{0.8} Fe_{0.8} Cr_{0.2} O_{3-δ} ceramic membrane and 8 L/min. of air flow at ambient air pressure on the air side of the membrane at a temperature of about 975° C. The COE membrane tube had a uniform wall thickness of 1 mm and a total area of about 44 cm².

### Example 5

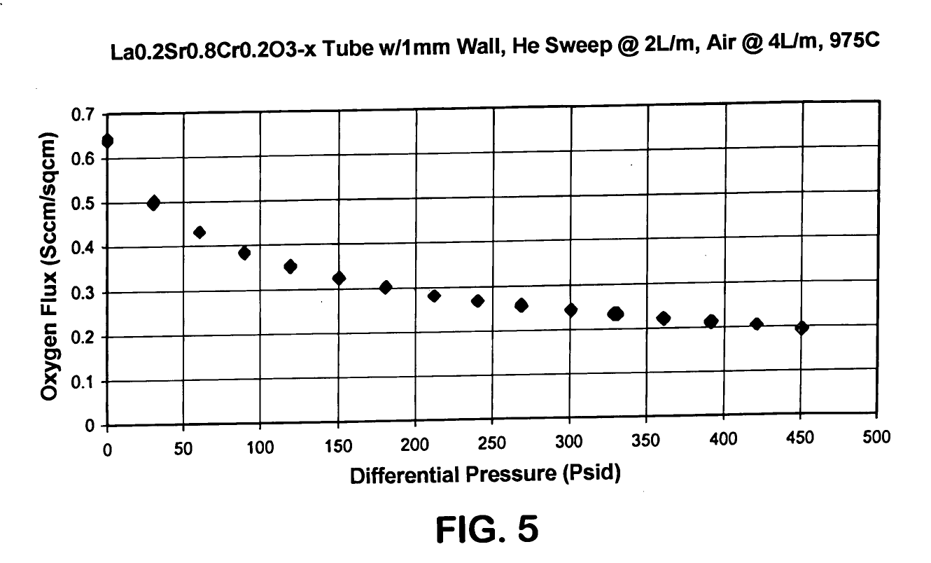

This example, as shown in FIG. 5, demonstrates the oxygen flux as a function of pressure with a neat helium sweep on the fuel side of the membrane or high pressure side of the membrane. The pressure effect is opposite of that with a hydrogen and carbon dioxide mixture or a steam and methane mixture. The oxygen flux decreases with increasing pressure. The decrease in flux was explained by the increase in the partial pressure of oxygen on the helium side of the membrane with increasing gas pressure.

### Example 6

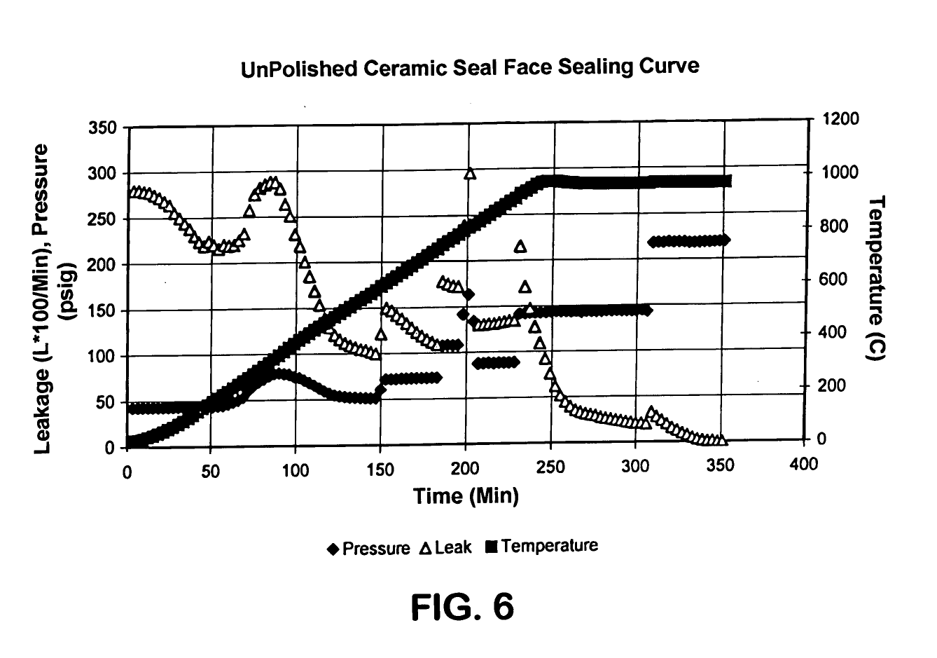

This example, as shown in FIG. 6, demonstrates the initial sealing to form a leakage resistant joint according to the invention without polishing of the tapered surface of the ceramic oxygen transport membrane. A fresh COE membrane tube with an unpolished seal face and fresh seal required no polishing. An excellent seal was established after the gold taper seal softened enough to fill the gaps. The pressure on the fuel started out low with a fairly large leak rate. But when the temperature was increased the pressure could be increased to form a robust seal.

### Example 7

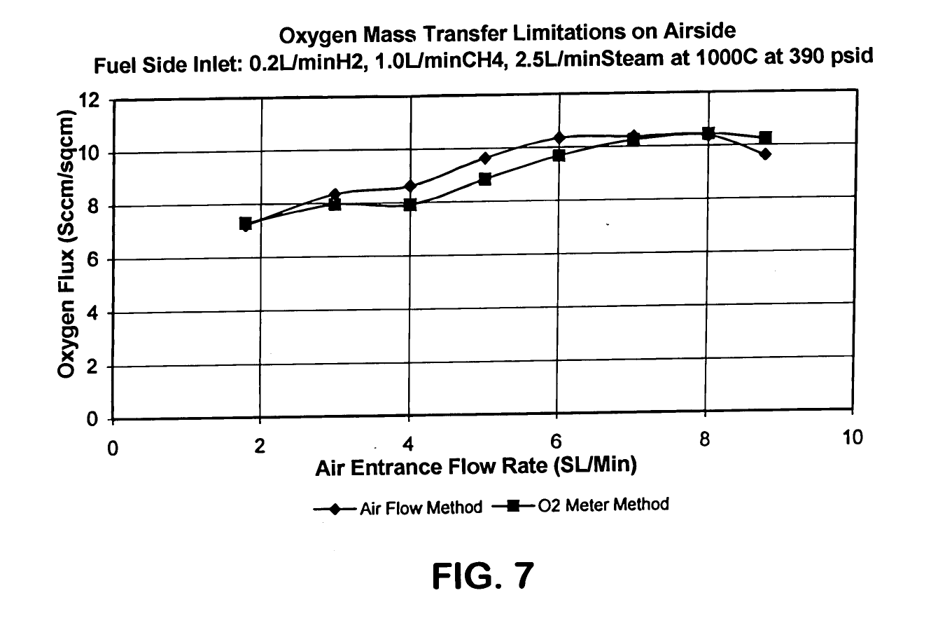

This example, as shown in FIG. 7, demonstrated the oxygen flux as a function of the air inlet flow rate for conversion at 1000° C. and 390 psid of a steam and methane gas inlet mixture. As shown the flux decreased with lower air flow rates.

Two methods were used to calculated the oxygen flux. The air flow method used the difference between the air flows in and out of the air side of the reactor. The difference was a measure of the oxygen transported by the membrane out of the air side of the reactor. The oxygen meter method measured the percent by volume of oxygen in minus the percent by volume of oxygen out of the air side of the reactor.

### Example 8

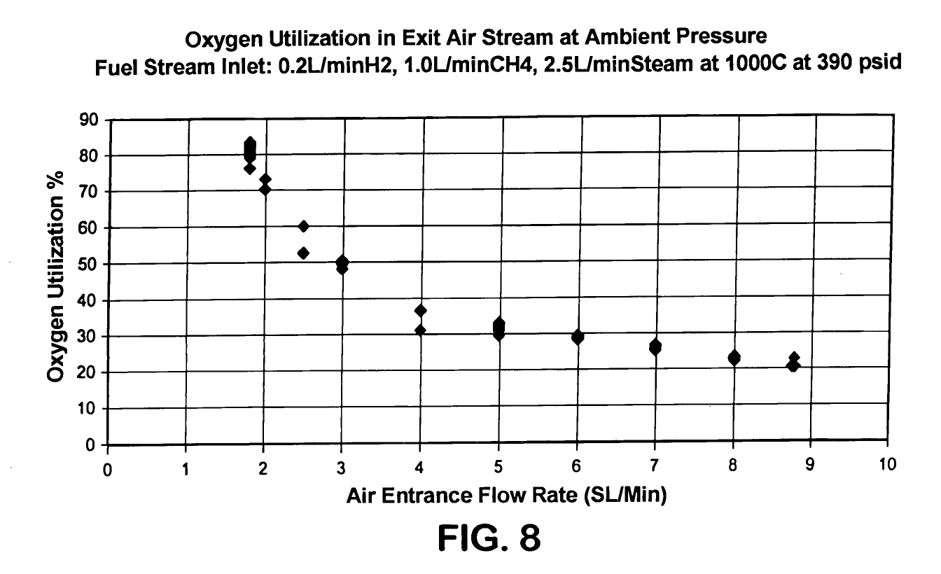

This example, as shown in FIG. 8, demonstrated the oxygen utilization rate in the exit air stream at ambient pressure for conversion of a steam/methane gaseous inlet mixture at 1000° C. and 390 psid. A penalty was paid in oxygen flux for utilization rates higher than 30 percent. A catalyst was used to allow the exit gases approach near equilibrium conversion of the steam and methane gas inlet mixture to form the syngas products.

For the purposes of the present invention, “predominantly” is defined as more than about fifty percent. “Substantially” is defined as occurring with sufficient frequency or being present in such proportions as to measurably affect macroscopic properties of an associated compound or system. The term “Essentially” is defined as absolutely except those small variations that have no more than a negligible effect on macroscopic qualities and final outcome are permitted, typically up to about one percent.

For the purposes of the present invention, “plastic deformation” is defined as permanent change in shape or size of a solid body without fracture resulting from the application of sustained stress beyond the elastic limit.

For the purposes of the present invention, “nonmetallic material” is defined as including materials formed substantially of metal oxides, for example by compressing and sintering a mixture of metallic and ceramic powers.

For the purposes of the present invention, a member which has a tubular structure may be open at both ends, or closed at one end, with a tapered outer surface at a one or both ends thereof. The tubular geometry will utilize any suitable cross-section, for example circular, elliptical, square, rectangular and other polygons, regular or irregular, having up to about 20 sides. Joints according the present invention are also advantageously used for reactors having cross-flow geometry, for example as disclosed in U.S. Pat. No. 5,356,728.

For the purposes of the present invention, “COE” is defined as including oxygen transport material fabricated in the form of a tube closed at one end.

Examples have been presented and hypotheses advanced herein in order to better communicate certain facets of the invention. The scope of the invention is determined solely by the scope of the appended claims.

1. A joint resistant to fluid leakage, which joint comprises a girdle of a metallic material capable of undergoing deformation without rupture that is disposed between and contiguous with tapered mating surfaces of a first rigid member and a second rigid member, wherein differential pressure across the joint provides compressive force upon the girdle through the mating surfaces thereby improving resistance to fluid leakage through the joint.

2. The joint according to claim 1 wherein the first rigid member comprises a nonmetallic material selected from the group consisting of glass, porcelain, and ceramic, and the second rigid member comprises a high strength metallic material capable of being welded, and the members exhibit different coefficients of thermal expansion.

3. The joint according to claim 1 wherein the girdle has a monolithic structure that undergoes plastic deformation thereby improving resistance to fluid leakage through the joint.

4. The joint according to claim 1 wherein the first rigid member includes a ceramic material comprising a crystalline mixed metal oxide which exhibits, at operating temperatures, electron conductivity, oxygen ion conductivity, and ability to separate oxygen from a gaseous mixture containing oxygen and one or more other components by means of the conductivities.

5. The joint according to claim 4 wherein the first rigid member has a tubular structure closed at one end with a tapered outer surface at a distal end of the rigid member which tapered surface is contiguous with a portion of the girdle.

6. The joint according to claim 5 wherein the girdle has a monolithic structure comprising a metallic material that has undergone plastic deformation thereby improving resistance to fluid leakage through the joint.

7. A joint resistant to fluid leakage, which joint comprises a first rigid member which has a tubular structure closed at one end with a tapered outer surface at a distal end thereof comprising a nonmetallic material selected from the group consisting of glass, porcelain, and ceramic; a girdle which has a tapered inner surface adapted to support the tapered outer surface of the first member, the girdle comprising a metallic material capable of undergoing deformation without rupture; and a second rigid member which has an orifice adapted to support the girdle, the second rigid member comprising a high strength metallic material capable of being welded, wherein a differential pressure across the joint provides compressive force upon the girdle.

8. The joint according to claim 7 wherein the nonmetallic material of the first rigid member and the high strength metallic material contiguous with the girdle exhibit different coefficients of thermal expansion.

9. The joint according to claim 8 wherein the first rigid member includes a dense ceramic material comprising a crystalline mixed metal oxide which exhibits, at operating temperatures, electron conductivity, oxygen ion conductivity, and ability to separate oxygen from a gaseous mixture containing oxygen and one or more other components by means of the conductivities.

10. The joint according to claim 7 wherein the girdle has a monolithic structure that undergoes plastic deformation thereby improving resistance to fluid leakage through the joint.

11. A joint resistant to fluid leakage, which joint comprises a composite girdle comprising two or more materials at least one of which materials is capable of undergoing deformation without rupture, a conduit comprising a metallic material capable of being welded with an inner tapered surface at a distal end thereof adapted to mate with an outer surface of the girdle, and a hollow ceramic member having at least one opening for flow communication with the conduit and an outer tapered surface adjacent to the opening adapted to mate with an inner surface of the girdle, wherein a differential pressure across the joint provides compressive force upon the girdle through the mating surfaces.

12. The joint according to claim 11 further comprising a mechanical means that provides compressive force upon the girdle through the mating surfaces.

13. The joint according to claim 11 wherein the ceramic member comprises a crystalline mixed metal oxide composition selected from a class of materials that have an X-ray identifiable crystalline structure based upon the structure of the mineral perovskite, CaTiO₃.

14. The joint according to claim 11 wherein the conduit comprises a high temperature alloy of at least one metallic element selected from the group consisting of aluminum, titanium, vanadium, chromium, iron, cobalt, nickel, molybdenum, and tungsten.

15. The joint according to claim 11 wherein the girdle has a monolithic structure comprising at least one metallic element selected from the group consisting of aluminum, copper, zinc, palladium, silver, tin, antimony, platinum, gold, lead and bismuth.

16. The joint according to claim 11 wherein the composite girdle comprises graphite imbedded in a metallic material capable of undergoing plastic deformation without rupture that is disposed between and contiguous with tapered mating surfaces.

17. The joint according to claim 11 wherein the girdle has a monolithic structure which comprises graphite with a coating of at least one metallic element selected from the group consisting of palladium, silver, platinum and gold, disposed to contact fluid on at least one side of the joint.

18. A process to convert organic compounds into value-added products, which process comprises:
(a-18) Providing a membrane reactor comprising a plurality of joints according to claim 1 or claim 11 wherein the ceramic member comprises a dense ceramic membrane comprising a crystalline mixed metal oxide which exhibits, at operating temperatures, electron conductivity, oxygen ion conductivity, and ability to separate oxygen from a gaseous mixture containing oxygen and one or more other components by means of the conductivities;
(b-18) Maintaining, at low pressure, a flow into the hollow ceramic member through the hollow girdle of an oxygen-containing gaseous mixture having a relatively high oxygen partial pressure;
(c-18) Contacting, at high pressure, the outer surface of the hollow ceramic member with a gaseous composition having a relatively lower oxygen partial pressure; and;
(d-18) Permitting oxygen to be transported through the dense ceramic membrane by means of its electron conductivity and oxygen ion conductivity thereby separating oxygen from the oxygen-containing gaseous mixture having a relatively higher oxygen partial pressure into the gaseous composition having a relatively lower oxygen partial pressure.

19. The process according to claim 18 wherein the dense ceramic membrane permeable to oxygen comprises a crystalline mixed metal oxide composition represented by
(D_{1-y}M′_{y})_{α}(E₁₋ₓGₓ)_{α+β}O_{δ}
where D is a metal selected from the group consisting of magnesium, calcium, strontium, and barium, M′ is a metal selected from the group consisting of magnesium, calcium, strontium, barium, copper, zinc, silver, cadmium, gold, mercury, yttrium, lanthanum and the lanthanides, E is an element selected from the group consisting of vanadium, chromium, manganese, iron, cobalt, and nickel, G is an element selected from the group consisting of vanadium, chromium, manganese, iron, cobalt, nickel, niobium, molybdenum, technetium, ruthenium, rhodium, palladium, indium, tin, antimony, rhenium, lead, and bismuth, with the proviso that D, E, G and NM are different elements, y is a number in a range from about zero to about one, x is a number in a range from about zero to about one, a is a number in a range from about 0.1 to about 4, β is a number in a range from 0 to about 20, with the proviso that
1≦(α+β)/α≦6,
and β is a number which renders the compound charge neutral.

20. The process according to claim 18 wherein the gaseous composition having a relatively lower oxygen partial pressure contains one or more organic compounds, and reacting at least one of the organic compounds with the oxygen transported through the membrane to form oxidation products at temperatures in a range from about 500° C. to about 1150° C.

21. The process according to claim 18 wherein the gaseous composition having a relatively lower oxygen partial pressure contains one or more organic compounds selected from the group consisting methanol, dimethyl ether, ethylene oxide, and hydrocarbons containing 1 to about 20 carbons, and the reaction products include synthesis gas comprising carbon monoxide and molecular hydrogen.

22. The process according to claim 18 wherein the gaseous composition having a relatively lower oxygen partial pressure is maintained at total pressure in a range upward from total pressure of the oxygen-containing gaseous mixture to obtain the differential pressures of at least 15 pounds per square inch across the joint which thereby provides compressive force upon the girdle through the mating surfaces.

23. The process according to claim 22 wherein the dense ceramic membrane permeable to oxygen comprises the crystalline mixed metal oxide composition represented by
La_{0.2}Sr_{0.8}Fe_{0.8}Cr_{0.2}O_{3-δ}
where δ is a number that renders the compound charge neutral.

24. The process according to claim 23 wherein the gaseous composition having a relatively lower oxygen partial pressure contains one or more organic compounds, and reacting at least one of the organic compounds with the oxygen transported through the membrane to form oxidation products at temperatures in a range from about 500° C. to about 1150° C.

25. The process according to claim 24 wherein the gaseous composition having a relatively lower oxygen partial pressure comprises methane, and the reaction products include synthesis gas comprising carbon monoxide and molecular hydrogen.
